(19) United States
(12) Patent Application Publication
(10) Pub. No.: US 2024/0356904 A1
(43) Pub. Date: Oct. 24, 2024

(54) SIGNATURE-LESS SELF-AUTHENTICATING ENCRYPTED MESSAGES VIA ASYMMETRIC KEY PAIRS

(71) Applicant: Encipher USA Corp., Houston, TX (US)

(72) Inventors: Jonathan Jao, Austin, TX (US); Robert Cyprus, Austin, TX (US)

(21) Appl. No.: 18/305,669

(22) Filed: Apr. 24, 2023

(51) Int. Cl. H04L 9/40; H04L 9/14; H04L 9/30; H04L 9/32

(52) U.S. Cl. CPC H04L 63/0442; H04L 9/14; H04L 9/3073; H04L 9/32

(57) ABSTRACT

In a technique of authenticated secure communication, a sender data processing system determines a message to be securely transmitted to a receiver data processing system. The sender data processing system generating a signature-less self-authenticating encrypted message by serially encrypting the message with a first encryption algorithm utilizing a private key of a first key pair assigned to the sender data processing system and with a second encryption algorithm utilizing a public key of a second key pair assigned to the receiver data processing system. Encrypting with the first encryption algorithm utilizing the private key authenticates the signature-less self-authenticating encrypted message as originating from the sender data processing system. The sender data processing system then communicates the signature-less self-authenticating encrypted message to the receiver data processing system.

### BACKGROUND OF THE INVENTION

This disclosure relates to data security and, in particular, to improved secure communication utilizing asymmetric encryption. Still more particularly, the present disclosure relates to secure communication utilizing signature-less self-authenticating encrypted messages.

Digital communication of a message from a sender to a receiver has several associated concerns, including confidentiality, integrity, and authenticity. Confidentiality (or security) refers to the desire of the sender and/or receiver of a message to restrict knowledge of the contents of the message to only authorized parties. Integrity refers to the ability of the receiver of the message to determine that the message contents have not been modified or tampered with after the message was sent by the sender. Authenticity refers to the ability of the receiver to verify that the message is likely sent by the sender, rather than a third party spoofing the sender.

In order to address these concerns a wide variety of cryptography schemes have been proposed and/or implemented. One class of cryptography schemes is asymmetric cryptography or public-key cryptography. In public-key encryption, a receiver can be assigned a pair of keys, including a private key and a public key generated from the private key utilizing a one-way function. Confidentiality of messages encrypted by public-key cryptography depends on the party to which a private key is assigned maintaining the private key secret; the public key can be freely distributed, however, without compromising message security. Thus, a sender can encrypt a message with the receiver's public key, yielding a ciphertext, which the receiver can then decrypt to obtain the original message using the receiver's corresponding private key.

With reference now to FIG. 1, there is illustrated a high-level data flow diagram of asymmetric message encryption and verification processes in accordance with the prior art. The process begins with a sender 100 (e.g., a first computer system) identifying a message 104 to be transmitted securely to a receiver 102 (e.g., a second computer system). According to the conventional process, the sender encrypts message 104 with the receiver's public key (R_Pub) 106 utilizing a selected encryption algorithm 108. The resulting encrypted message (or ciphertext) 110 can then be securely transmitted (e.g., over a network, such as the Internet) to receiver 102 without concern that the contents of message 104 can be intercepted and deciphered.

Sender 100 additionally generates a separate datum referred to in the art as a “signature,” which can be utilized to enable verification of the message. To generate the signature, sender 100 applies a hash algorithm 120 to message 104 to obtain an abbreviated hash of message 104, referred to as a digest 122. Sender 100 encrypts digest 122 with the sender's private key (S_Priv) 124 utilizing a digest encryption algorithm 126. The sender transmits the resulting signature 128 to receiver 102 in conjunction with encrypted message 110 to enable verification that encrypted message 110 originated from sender 100.

In response to receiving encrypted message 110 and the associated signature 128, receiver 102 decrypts encrypted message 110 with decryption algorithm 130 utilizing the receiver's private key (R_Priv) 132, which is the private key paired with the receiver's public key (R_Pub) 106. The result of this decryption is original message 134, which corresponds exactly to original message 104, assuming correct key pairing and no corruption of the encrypted message from the transmission channel. It should be noted that R_Priv 132 is the only key that can be utilized to decrypt encrypted message 110 to obtain original message 134.

In order to authenticate that message 134 originated with sender 100, receiver 102 performs a verification process on signature 128. In the verification process, receiver 102 applies hash algorithm 120 to message 134 to generate a first digest 136. Receiver 102 also decrypts signature 128 with the sender's public key (S_Pub) 140 utilizing a digest decryption algorithm 142 to obtain a second digest 144. Sender's public key (S_Pub) 140 is the public key corresponding to sender's private key (S_Priv) 124. Receiver 102 then performs a logical comparison of digests 136 and 144 to verify signature 128 at block 150. If logical comparison 150 determines that digests 136 and 144 match, then signature 128 passes verification, and the receiver 102 is assured that message 134 originated from sender 100; otherwise, signature 128 fails verification, and message 134 cannot be verified as originating with sender 100.

### BRIEF SUMMARY

The present application appreciates that conventional public key cryptography has a heretofore unrecognized vulnerability because the verification process at the receiver that performs the logical comparison of message digests to verify the sender's digital signature can be compromised, for example, by malicious code executing at the receiver. As a result, the logical comparison of the message digests conventionally utilized to authenticate the identity of the sender of a message may erroneously verify the signature of a message transmitted by a malicious third party, incorrectly authenticating that the message originated from a trusted sender. Consequently, the content of the message may be stored, executed, transmitted or otherwise processed at the sender and/or other data processing system(s), leading to unintended disclosure of data (e.g., encryption keys) and/or compromise of one or more data processing systems.

In one or more embodiments, the vulnerability associated with the conventional logical comparison of message digests performed by the receiver can be foreclosed by eliminating the logical comparison of message digests to perform signature verification and by instead employing an unconventional use of the sender's private key (rather than the receiver's public key) to encrypt the message to obtain a signature-less self-authenticating encrypted message.

In a technique of authenticated secure communication, a sender data processing system determines a message to be securely transmitted to a receiver data processing system. The sender data processing system generates a signature-less self-authenticating encrypted message by serially encrypting the message with a first encryption algorithm utilizing a private key of a first key pair assigned to the sender data processing system and with a second encryption algorithm utilizing a public key of a second key pair assigned to the receiver data processing system. Encrypting with the first encryption algorithm utilizing the private key authenticates the signature-less self-authenticating encrypted message as originating from the sender data processing system. The sender data processing system then communicates the signature-less self-authenticating encrypted message to the receiver data processing system.

### BRIEF DESCRIPTION OF THE SEVERAL VIEWS OF THE DRAWINGS

FIG. 1 is a high-level data flow diagram of message encryption and verification processes in accordance with the prior art;

FIG. 2 is a high-level block diagram of a data processing environment in accordance with one embodiment;

FIG. 3A is a data flow diagram of signature-less self-authenticating message encryption and cryptographic verification processes in accordance with one embodiment;

FIG. 3B is a data flow diagram of signature-less self-authenticating message encryption and cryptographic verification processes in accordance with another embodiment;

FIG. 4 is a high-level logical flowchart of an exemplary process by which a message sender utilizes asymmetric encryption to generate a signature-less self-authenticating encrypted message in accordance with one embodiment;

FIG. 5 is high-level logical flowchart of an exemplary process by which a message receiver decrypts and cryptographically verifies a signature-less self-authenticating encrypted message in accordance with one embodiment;

FIG. 6A is a data flow diagram of processes for signature-less self-authenticating message multi-encryption and cryptographic verification in accordance with one embodiment; and

FIG. 6B is a data flow diagram of processes for signature-less self-authenticating message encryption and cryptographic multi-verification in accordance with one embodiment.

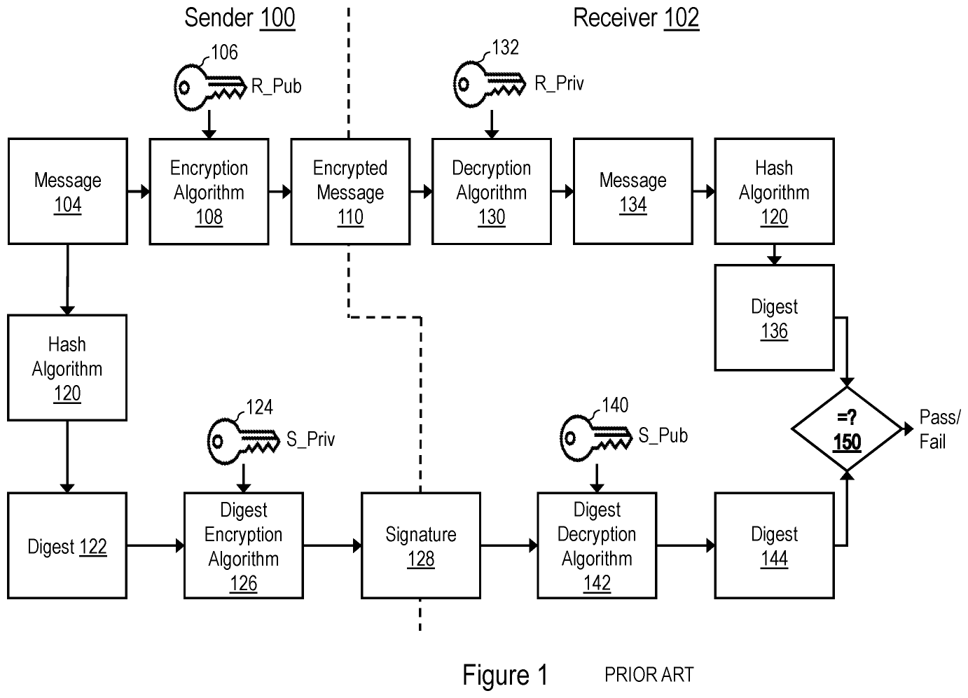

### DETAILED DESCRIPTION

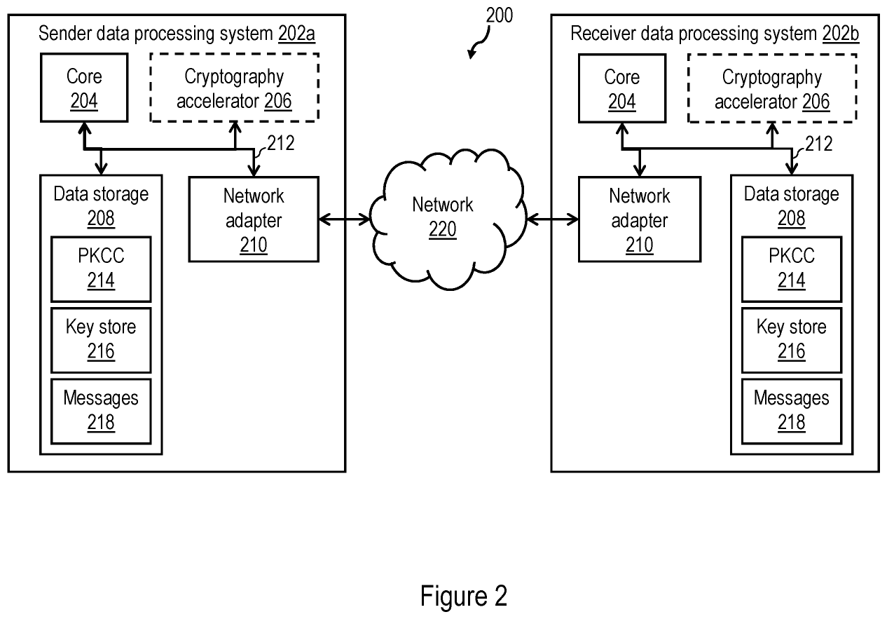

Referring again to the figures and, in particular, with reference to FIG. 2, there is depicted a data processing environment 200 in accordance with one embodiment. Data processing environment 200 includes a plurality of data processing systems 202, including a first data processing system 202a which can be identified with respect to communication of a particular message as a sender data processing system or “sender,” and a second data processing systems 202b, which can be identified with respect to communication of a particular message as a receiver data processing system or “receiver.” Those skilled in the art will appreciate that, with respect to other messages, receiver data processing system 202b can act as a sender, and sender data processing system 202a can act as a receiver. Sender data processing system 202a and receiver data processing system 202b are coupled for communication by an electronic communication network 220, which may include one or more public or private networks, such as the Internet.

Each data processing system 202 includes at least one processor core 204 for processing instructions and data. In some embodiments, the instructions executed by core 204 include public key cryptography code (PKCC) 214 that encrypts messages 218 transmitted over network 220 and that decrypts and validates messages received from network 220. In some embodiments, a given data processing system 202 may optionally include a cryptography accelerator 206 that implements public key cryptography in hardware and/or in software and/or in firmware. In some implementations, cryptography accelerator 206 can be integrated within a same integrated circuit as processor core 204. Each data processing system 202 further includes data storage 208 for storing data, such as public key cryptography code 214, a key store 216 (e.g., for one or more public key/private key pairs and possibly one or more symmetric keys), and messages 218. Each data processing system 202 additionally includes a network adapter 210 coupling the data processing system 202 for communication with network 220. Finally, data processing system 202 includes a bus 212 communicatively coupling core 204, cryptography accelerator 206 (if present), data storage 208, and network adapter 210.

Those skilled in the art will appreciate that the data processing environment 200 depicted in FIG. 2 omits many commonly understood details in order to avoid obscuring features of the inventions disclosed herein. Additionally, it should be understood that the disclosed inventions are not limited by the general data processing system architecture depicted in FIG. 2 and may be implemented in data processing environments including differing components.

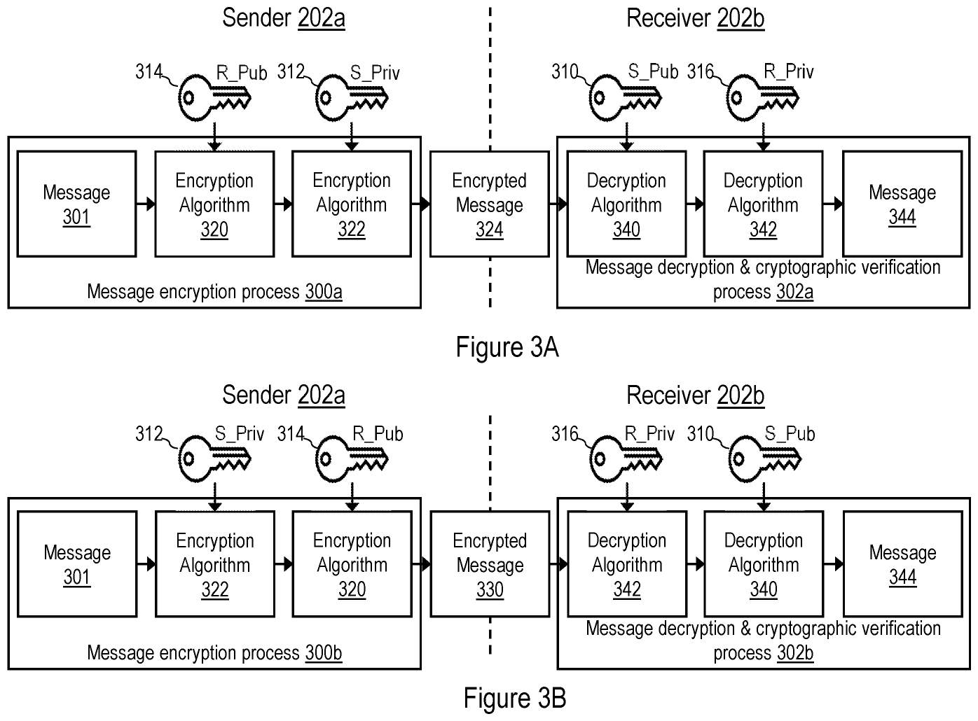

With reference now to FIG. 3A, there is illustrated a data flow diagram of message encryption and cryptographic verification processes in accordance with one embodiment. In this example, sender data processing system 202a performs a message encryption process 300a, and receiver data processing system 202b performs a corresponding message decryption and cryptographic verification process 302a. The depicted processes can be performed in hardware, software, and/or firmware in the exemplary data processing environment 200 of FIG. 2. For example, the depicted processes can be implemented in whole or part through the execution of PKCC 214 by cores 204 and/or cryptography accelerators 206. Alternatively or additionally, the depicted processes can be performed in whole or part in hardware or firmware by cores 204 and/or cryptography accelerators 206.

In performing the illustrated processes, sender 202a has in its key store 216 the receiver public key (R_Pub) 314 generated by receiver 202b, as well as its own associated key pair, including sender public key (S_Pub) 310 and sender private key (S_Priv) 312. Receiver 202b has in its key store 216 the sender public key (S_Pub) 310 generated by sender 202a, as well as its own associated key pair, including receiver public key (R_Pub) 314 and receiver private key (R_Priv) 316. In at least some embodiments, each of sender 202a and receiver 202b can generate its own private key and then generate the corresponding public key utilizing a one-way function. Each of sender 202a and receiver 202b can then publish its public key 310 or 314 for use by other communication participants, while retaining its respective private key 312 or 316 as a secret.

Turning first to message encryption process 300a, sender 202a receives, computes, generates or otherwise determines a message 301 to be securely transmitted to receiver 202b. The message can include, for example, text, program code, a symmetric encryption key, or other data to be securely transmitted to receiver 202b. In message encryption process 300a, sender 202a first encrypts message 301 with an encryption algorithm 320 utilizing R_Pub 314. Encryption algorithm 320 secures the contents of message 301 in that (assuming encryption algorithm 320 is not broken) only a communication participant having the private key corresponding to R_Pub 314 (i.e., R_Priv 316) will be able to decrypt the ciphertext produced by encryption algorithm 320. Sender 202a then serially encrypts the ciphertext resulting from encryption algorithm 320 with encryption algorithm 322 utilizing S_Priv 312 to produce encrypted message 324. The encryption applied by encryption algorithm 322 authenticates encrypted message 324 as originating from sender 202a because only sender 202a possesses S_Priv 312. Because of the authentication inherent in encryption utilizing S_Priv, no additional signature datum is or need be generated to verify encrypted message 324, as discussed further below. Thus, encrypted message 324 is a signature-less self-authenticating encrypted message. In various embodiments, encryption algorithms 320 and 322 can be the same or different encryption algorithms, and can be, for example, one of the RSA (Rivest-Shamir-Adleman) or Elliptic Curve Cryptography (ECC) algorithms. Following message encryption process 300a, sender 202a transmits the encrypted message 324 output by message encryption process 300a to receiver 202b via network 220 of FIG. 2.

In response to receiving encrypted message 324, receiver 202b processes encrypted message 324 utilizing message decryption and cryptographic verification process 302a. In message decryption and cryptographic verification process 302a, receiver 202b first decrypts encrypted message 324 with a decryption algorithm 340 utilizing S_Pub 310. Decryption algorithm 340 corresponds to and decrypts the encryption applied by encryption algorithm 322. Success in decrypting encrypted message 324 with decryption algorithm 340 constitutes cryptographic verification of the authenticity of encrypted message 324. Receiver 202b then serially decrypts the ciphertext resulting from decryption algorithm 340 with decryption algorithm 342 utilizing R_Priv 316. Decryption algorithm 342 corresponds to and decrypts the encryption applied by encryption algorithm 320. Receiver 202b can then store, transmit, execute, or otherwise process message 344 obtained by message decryption and cryptographic verification process 302a, where message 344 is identical to the original message 301 of sender 202a.

Referring now to FIG. 3B, there is illustrated a data flow diagram of message encryption and cryptographic verification processes in accordance with another embodiment. FIG. 3B illustrates that the encryption algorithm 320 applied for message security and the encryption algorithm 322 applied to provide message encryption and self-authentication can be performed serially in any order. In this example, message encryption and cryptographic verification process 300b of FIG. 3B performs encryption algorithm 322 (used to encrypt and self-authenticate message 301) prior to encryption algorithm 320 (used to secure message 301). Given this ordering of operations, message decryption and signature verification process 302b correspondingly performs decryption algorithm 342 prior to decryption algorithm 340. Despite the reversal of the order in which the encryption and decryption operations are performed, resultant message 344 in FIG. 3B obtained by receiver 202b is identical to message 344 in FIG. 3A.

Those skilled in the art will appreciate that message encryption processes 300a, 300b differ from prior art processes in several ways. For example, message encryption processes 300a, 300b apply the encryption authenticating sender 202a directly to the data of message 301 rather than a hash or digest of message 301 as in the prior art. Thus, only one “datum” or message need be transmitted from sender 202a to receiver 202b, rather than a message and a separate signature as in the prior art. Sender 202a accordingly preferably refrains from sending a separate digest or signature to receiver 202b. In addition, existing code libraries for interpreted and compiled languages (e.g., Python, C, etc.) do not permit encryption of message data utilizing private keys, which are conventionally employed only for data decryption. Similarly, the Public Key Cryptography Standards (PKCS) published by RSA Security LLC, which include RSA Cryptography Standard Version 2.2 (PKCS #1) and Cryptographic Message Syntax Standard Version 1.5 (PKCS #7), only discuss encryption of message data with public keys. Consequently, by encrypting message 301 (or a ciphertext of message 301 as in FIG. 3A) utilizing S_Priv key 312, message encryption processes 300a, 300b proceed directly contrary to known cryptography techniques. It should also be noted that message encryption processes 300a or 300b performed by sender 202a do not employ “double encryption” as that term is understood in the art because only one of the encryption steps in message encryption and digital signature process 300a or 300b uses a public key.

With respect to the processing performed by receiver 202b, it should be noted that message decryption and cryptographic verification processes 302a, 302b omit (i.e., refrain from performing) any logical equivalence check to verify digest or signature data (as in the prior art). Instead, failure of decryption process 340 implicitly flags encrypted message 324 as either having been compromised in transit (i.e., a lack of integrity) or having been sent by an untrusted sender (i.e., a lack of authentication) and renders the data of encrypted message 324 or 330 unreadable. Message decryption and cryptographic verification processes 302a, 302b thus provide true “trustless” verification in that the potential vulnerability of the post-decryption logical equivalence checking conventionally applied to message digests is eliminated, and the verification is implicit in the cryptographic result.

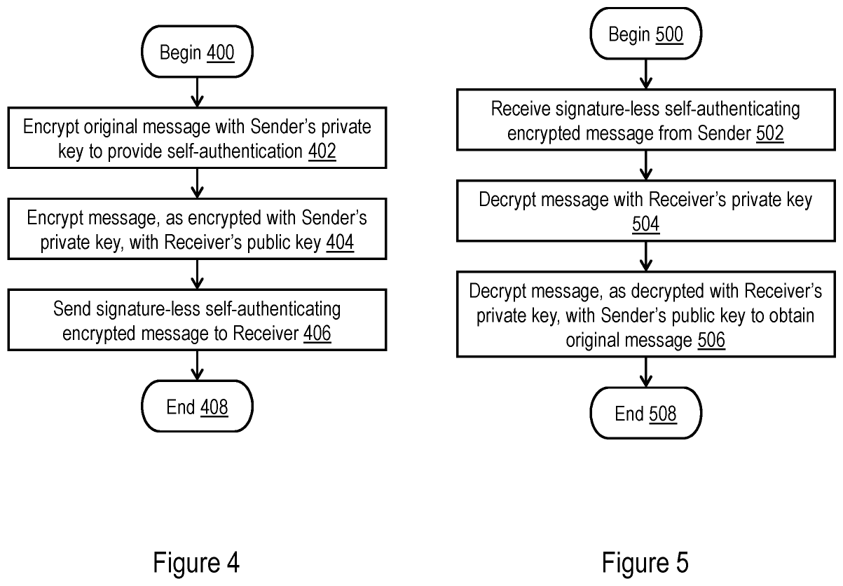

Referring now to FIG. 4, there is depicted a high-level logical flowchart of an exemplary process by which a message sender encrypts a message in accordance with one embodiment. The process of FIG. 4, which can be performed, for example, by a processor of sender 202a (e.g., core 204 or cryptography accelerator 206) in hardware, software, and/or firmware, is described below with additional reference to the data flow presented in FIG. 3B.

The process of FIG. 4 begins at block 400, for example, in response to receipt of a message 301 to be transmitted to sender 202b in a secure and verifiable manner. The process proceeds from block 400 to block 402, which illustrates sender 202a encrypting message 301 with encryption algorithm 322 utilizing S_Priv 312 (block 402). Sender 202a then serially encrypts the ciphertext resulting from encryption algorithm 322 with encryption algorithm 320 utilizing R_Pub 314 (block 404). Sender 202a then transmits the signature-less self-authenticating encrypted message 330 output by encryption algorithm 320 to receiver 202b via network 220.

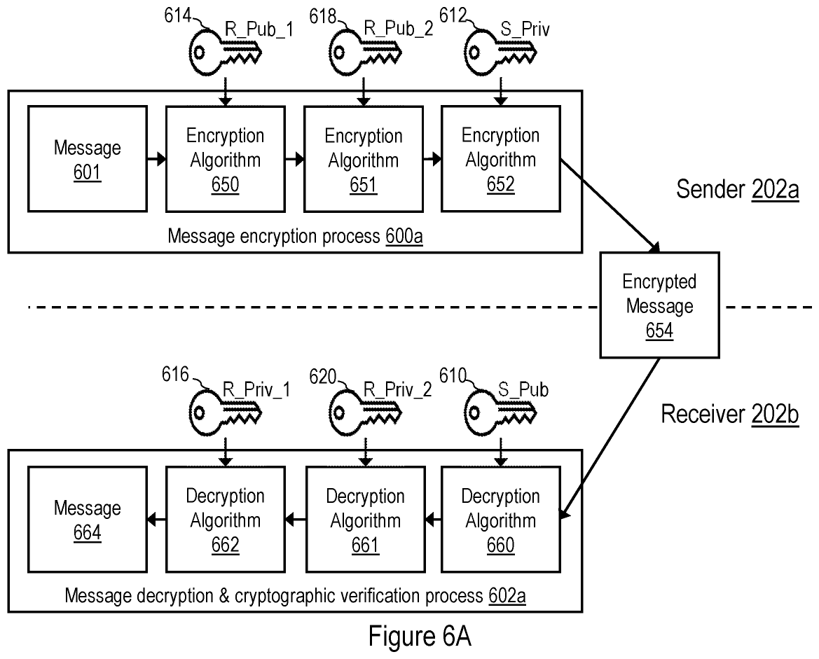

With reference now to FIG. 5, there is illustrated a high-level logical flowchart of an exemplary process by which a message receiver decrypts and cryptographically verifies a signature-less self-authenticating encrypted message in accordance with one embodiment. The process of FIG. 5, which can be performed, for example, by a processor of receiver 202b (e.g., core 204 or cryptography accelerator 206) in hardware, software, and/or firmware, is described below with additional reference to the data flow presented in FIG. 3B.

The process of FIG. 5 begins at block 500 and then proceeds to block 502, which illustrates receiver 202b receiving signature-less self-authenticating encrypted message 330 from sender 202a. In response to receipt of signature-less self-authenticating encrypted message 330, receiver 202b first decrypts encrypted message 330 with a decryption algorithm 342 utilizing R_Priv 316 (block 504). As noted above, decryption algorithm 342 corresponds to and decrypts the encryption applied by encryption algorithm 320 at sender 202a. Receiver 202b then serially decrypts the ciphertext resulting from decryption algorithm 342 with decryption algorithm 340 utilizing S_Pub 310 (block 506). Decryption algorithm 340 corresponds to and decrypts the encryption applied by encryption algorithm 322 of sender 202a. Success of decryption algorithm 340 in decrypting the ciphertext resulting from decryption algorithm 342 verifies the authenticity of signature-less self-authenticating encrypted message 330 as originating from sender 202a. Assuming correct key pairing and no corruption of encrypted message 330 in transit on network 220, decryption algorithm 340 outputs message 344 corresponding to original message 301. Receiver 202b can then store, transmit, execute, or otherwise process message 344 obtained by message decryption process 302b.

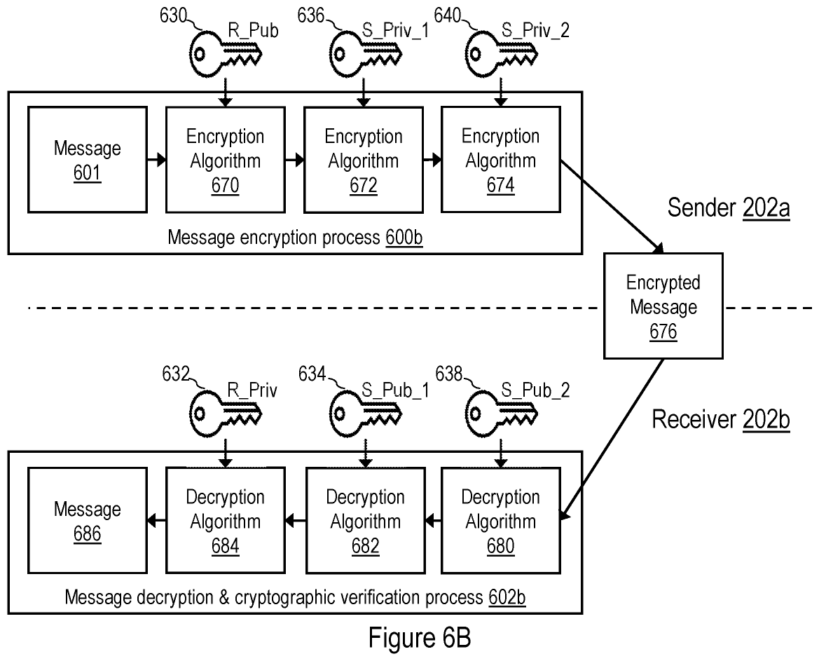

The above-described processes for encryption and cryptographic verification can be further extended to provide enhanced security through multi-encryption and/or multi-verification. A data flow diagram of one exemplary multi-encryption and cryptographic verification process is given in FIG. 6A, and a data flow diagram of an exemplary encryption and multi-verification process is given in FIG. 6B. In FIG. 6A multiple encryption steps are performed to secure contents of a message prior to self-authenticating the encrypted message, whereas in FIG. 6B multiple encryption steps are employed to self-authenticate the message following encrypting the message contents for security.

Referring now to FIG. 6A, sender data processing system 202a performs a message encryption process 600a, and receiver data processing system 202b performs a corresponding message decryption and cryptographic verification process 602a. The depicted processes can be performed in hardware, software, and/or firmware in the exemplary data processing environment 200 of FIG. 2. For example, the depicted processes can be implemented in whole or part through the execution of PKCC 214 by cores 204 and/or cryptography accelerators 206. Alternatively or additionally, the depicted processes can be performed in whole or part in hardware or firmware by cores 204 and/or cryptography accelerators 206.

In FIG. 6A, sender 202a is assigned a first key pair including sender public key (S_Pub) 610 and sender private key (S_Priv) 612, and receiver 202b is assigned a second key pair including receiver public key 1 (R_Pub_1) 614 and receiver private key 1 (R_Pub_1) 616 and a third key pair including receiver public key 2 (R_Pub_2) 618 and receiver private key 2 (R_Priv_2) 620. As described above, each of sender 202a and receiver 202b can generate each its own private keys and generate the corresponding public keys utilizing a one-way function, as is known in the art. Each of sender 202a and receiver 202b can then publish its public keys for use by other communication participants, while retaining its respective private keys secret.

In message encryption and digital signature process 600a, sender 202a receives, computes, generates or otherwise determines a message 601 to be securely transmitted to receiver 202b. As above, message 601 can include, for example, text, program code, a symmetric encryption key, or other data to be securely transmitted via network 220 to receiver 202b. In message encryption process 600a, sender 202a serially doubly encrypts message 601 with an encryption algorithm 650 utilizing R_Pub_1 key 614 and then with encryption algorithm 651 utilizing R_Pub_2 key 618. Encryption algorithms 650 and 651 secure the contents of message 601. Sender 202a then self-authenticates the ciphertext resulting from encryption algorithm 651 by applying encryption algorithm 652 utilizing S_Priv key 612, resulting in signature-less self-authenticating encrypted message 654. Encryption algorithms 650, 651, and 652 can be the same or different encryption algorithms, and can be, for example, RSA or ECC. Sender 202a then transmits signature-less self-authenticating encrypted message 654 output by message encryption process 600a to receiver 202b via network 220.

Still referring to FIG. 6A, in response to receiving signature-less self-authenticating encrypted message 654, receiver 202b processes encrypted message 654 utilizing message decryption and cryptographic verification process 602a. In message decryption and cryptographic verification process 602a, receiver 202b first decrypts signature-less self-authenticating encrypted message 654 with a decryption algorithm 660 utilizing S_Pub key 610. Decryption algorithm 660 corresponds to and decrypts the encryption applied by encryption algorithm 652. Success of decryption algorithm 660 in decrypting the encryption applied by encryption algorithm 652 verifies the authenticity of signature-less self-authenticating encrypted message 654 as originating from sender 202a. Receiver 202b then serially decrypts the ciphertext resulting from decryption algorithm 660 with decryption algorithm 661 utilizing R_Priv_2 620 and decrypts the ciphertext resulting from decryption algorithm 661 with decryption algorithm 662 utilizing R_Priv_1 616. Decryption algorithms 661 and 662 correspond to and decrypt the encryption applied by encryption algorithms 651 and 650, respectively. Assuming correct key pairing and no corruption of encrypted message 654 in transit on network 220, decryption algorithm 662 outputs a message 664 corresponding to original message 601. Receiver 202b can then store, transmit, execute, or otherwise process message 664 obtained by message decryption and cryptographic verification process 602a.

It should be noted the encryption algorithm(s) applied for message security and the encryption algorithm(s) applied to provide message encryption and self-authentication can be performed by sender 202a serially in any order. Receiver 202b then applies the corresponding decryptions in the reverse order to decrypt and cryptographically verify the signature-less self-authenticating encrypted message.

Referring now to FIG. 6B, sender data processing system 202a performs a message encryption process 600b, and receiver data processing system 202b performs a corresponding message decryption and cryptographic verification process 602b. The depicted processes can be performed in hardware, software, and/or firmware in the exemplary data processing environment 200 of FIG. 2. For example, the depicted processes can be implemented in whole or part through the execution of PKCC 214 by cores 204 and/or cryptography accelerators 206. Alternatively or additionally, the depicted processes can be performed in whole or part in hardware or firmware by cores 204 and/or cryptography accelerators 206.

In FIG. 6B, sender 202a is assigned a first key pair including sender public key 1 (S_Pub_1) 634 and sender private key 1 (S_Priv_1) 636 and a second key pair including sender public key 2 (S_Pub_2) 638 and sender private key 2 (S_Priv_2) 640. Receiver 202b is assigned a third key pair including receiver public key (R_Pub) 630 and receiver private key (R_Priv) 632. As described above, each of sender 202a and receiver 202b can generate its own private keys and generate the corresponding public keys utilizing a one-way function, as is known in the art. Each of sender 202a and receiver 202b can then publish its public keys for use by other communication participants, while retaining its respective private keys secret.

In message encryption process 600b, sender 202a receives, computes, generates or otherwise determines a message 601 to be securely transmitted to receiver 202b. As above, message 601 can include, for example, text, program code, a symmetric encryption key, or other data to be securely transmitted via network 220 to receiver 202b. In message encryption process 600b, sender 202a first encrypts message 601 with an encryption algorithm 670 utilizing R_Pub key 630 to secure the contents of message 601. Sender 202a then self-authenticates the ciphertext resulting from encryption algorithm 670 by serially applying encryption algorithms 672 and 674 utilizing S_Priv_1 key 636 and S_Priv_2 640, respectively, resulting in signature-less (double) self-authenticating encrypted message 676. Encryption algorithms 670, 672, and 674 can be the same or different encryption algorithms, and can be, for example, RSA or ECC. Sender 202a then transmits the encrypted message 676 output by message encryption process 600b to receiver 202b via network 220.

Still referring to FIG. 6B, in response to receiving encrypted message 676, receiver 202b processes encrypted message 676 utilizing message decryption and cryptographic verification process 602b. In message decryption and cryptographic verification process 602b, receiver 202b first validates encrypted message 676 as originating from sender 202a by serially applying decryption algorithms 680 and 682 utilizing S_Pub_2 638 and S_Pub_1 634, respectively. Decryption algorithms 680 and 682 corresponds to and decrypts the encryption applied by encryption algorithms 674 and 672, respectively. Receiver 202b then decrypts the ciphertext resulting from decryption algorithm 682 with decryption algorithm 684 utilizing R_Priv 632. Decryption algorithm 684 corresponds to and decrypts the encryption applied by encryption algorithm 670. Assuming correct key pairing and no corruption of encrypted message 676 in transit on network 220, decryption algorithm 684 outputs message 686 corresponding to original message 601. Receiver 202b can then store, transmit, execute, or otherwise process message 686 obtained by message decryption and signature verification process 602b.

It should be noted the encryption algorithm(s) applied for message security and the encryption algorithm(s) applied to provide message encryption and self-authentication can be performed by sender 202a serially in any order. Receiver 202b then applies the corresponding decryptions in the reverse order to decrypt and cryptographically verify the signature-less self-authenticating encrypted message. Further, it should be appreciated for a given message the any desired number of encryption steps can be performed for message security and any desired number of encryption steps can be performed message self-authentication.

In data processing system environments 200 in which message bandwidth and throughput are not concerns, asymmetric message encryption processes as described herein can be utilized to secure each message packet transmitted from a sender 202a to a receiver 202b. However, in many common use cases, performing asymmetric encryption and decryption on each message packet is impractical, given the computational complexity of the encryption and decryption algorithms involved (which continues to increase in order to harden message security against brute force attacks). Consequently, in order to support both security and high data transmission rates, a sender 202a can securely communicate a secret symmetric encryption key to receiver 202b by encrypting and self-authenticating the symmetric encryption key as the “message” utilizing the public key (asymmetric) encryption processes described above. Sender 202a can then secure subsequent message packets in the message stream by performing symmetric encryption utilizing the symmetric encryption key (which can also be employed by the receiver 202b to decrypt the subsequent message packets).

As has been described, in at least one embodiment, a sender data processing system determines a message to be securely transmitted to a receiver data processing system. The sender data processing system generating a signature-less self-authenticating encrypted message by serially encrypting the message with a first encryption algorithm utilizing a private key of a first key pair assigned to the sender data processing system and with a second encryption algorithm utilizing a public key of a second key pair assigned to the receiver data processing system. Encrypting with the first encryption algorithm utilizing the private key authenticates the signature-less self-authenticating encrypted message as originating from the sender data processing system. The sender data processing system then communicates the signature-less self-authenticating encrypted message to the receiver data processing system.

While various embodiments have been particularly shown and described, it will be understood by those skilled in the art that various changes in form and detail may be made therein without departing from the spirit and scope of the appended claims and these alternate implementations all fall within the scope of the appended claims. For example, although aspects have been described with respect to a computer system executing program code that directs the functions of the present invention, it should be understood that present invention may alternatively be implemented as a program product including a computer-readable storage device storing program code that can be processed by a processor of a data processing system to cause the data processing system to perform the described functions. The computer-readable storage device can include volatile or non-volatile memory, an optical or magnetic disk, or the like, but excludes non-statutory subject matter, such as propagating signals per se, transmission media per se, and forms of energy per se.

As an example, the program product may include data and/or instructions that when executed or otherwise processed on a data processing system generate a logically, structurally, or otherwise functionally equivalent representation (including a simulation model) of hardware components, circuits, devices, or systems disclosed herein. Such data and/or instructions may include hardware-description language (HDL) design entities or other data structures conforming to and/or compatible with lower-level HDL design languages such as Verilog and VHDL, and/or higher level design languages such as C or C++. Furthermore, the data and/or instructions may also employ a data format used for the exchange of layout data of integrated circuits and/or symbolic data format.

The figures described herein and the written description of specific structures and functions are not presented to limit the scope of what Applicants have invented nor the scope of the appended claims. Rather, the figures and written description are provided to teach any person skilled in the art to make and use the inventions for which patent protection is sought. Those skilled in the art will appreciate that not all features of a commercial embodiment of the inventions are described or shown for the sake of clarity and understanding. Persons of skill in this art will also appreciate that the development of an actual commercial embodiment incorporating aspects of the present inventions will require numerous implementation-specific decisions to achieve the developer's ultimate goal for the commercial embodiment. Such implementation-specific decisions may include, and likely are not limited to, compliance with system-related, business-related, government-related and other constraints, which may vary by specific implementation, location and from time to time. While a developer's efforts might be complex and time-consuming in an absolute sense, such efforts would be, nevertheless, a routine undertaking for those of skill in this art having benefit of this disclosure. It must be understood that the inventions disclosed and taught herein are susceptible to numerous and various modifications and alternative forms. Lastly, the use of a singular term, such as, but not limited to, “a” is not intended as limiting of the number of items.

What is claimed is:

1. A method of authenticated secure communication utilizing asymmetric encryption, the method comprising:
a sender data processing system determining a message to be securely transmitted to a receiver data processing system;
the sender data processing system generating a signature-less self-authenticating encrypted message by serially encrypting the message with a first encryption algorithm utilizing a private key of a first key pair assigned to the sender data processing system and with a second encryption algorithm utilizing a public key of a second key pair assigned to the receiver data processing system, wherein encrypting with the first encryption algorithm utilizing the private key authenticates the signature-less self-authenticating encrypted message as originating from the sender data processing system; and
the sender data processing system communicating the signature-less self-authenticating encrypted message to the receiver data processing system.

2. The method of claim 1, wherein the serially encrypting includes:
the sender data processing system encrypting the message with the second encryption algorithm and then the first encryption algorithm.

3. The method of claim 1, wherein the first and second encryption algorithms are a same cryptographic algorithm.

4. The method of claim 1, wherein the first and second encryption algorithms are different cryptographic algorithms.

5. The method of claim 1, wherein the message comprises a symmetric encryption key.

6. The method of claim 1, wherein encrypting the message with the sender private key comprises serially encrypting the message utilizing multiple sender private keys including the sender private key.

7. The method of claim 1, wherein encrypting the message with the receiver public key comprises serially encrypting the message utilizing multiple receiver public keys.

8. The method of claim 1, wherein encrypting the message comprises serially encrypting the message utilizing multiple private keys including the sender private key and multiple receiver public keys including the receiver public keys.

9. The method of claim 1, wherein the communicating includes the sender data processing system refraining from transmitting a separate message digest of the message to the receiver data processing system.

10. The method of claim 1, further comprising:
the receiver data processing system serially decrypting the signature-less self-authenticating encrypted message with a first decryption algorithm utilizing a private key of the second key pair and with a second decryption algorithm utilizing a public key of the first key pair, wherein decrypting with the second decryption algorithm verifies the sender data processing system as originating the signature-less self-authenticating encrypted message.

11. The method of claim 10, wherein the receiver data processing system refrains from performing a logical comparison operation to verify any digital signature.

12. The method of claim 10, wherein the receiver data processing system refrains from performing any logical comparison operation to verify the sender processing system as originating the signature-less self-authenticating encrypted message.

13. A sender data processing system, comprising:
a network adapter;
data storage;
a processor coupled to the network adapter and the data storage, wherein the processor is configured to perform:
determining a message to be securely transmitted to a receiver data processing system;
generating a signature-less self-authenticating encrypted message by serially encrypting the message with a first encryption algorithm utilizing a private key of a first key pair assigned to the sender data processing system and with a second encryption algorithm utilizing a public key of a second key pair assigned to the receiver data processing system, wherein encrypting with the first encryption algorithm utilizing the private key authenticates the signature-less self-authenticating encrypted message as originating from the sender data processing system; and
communicating the signature-less self-authenticating encrypted message to the receiver data processing system.

14. The sender data processing system of claim 13, wherein the serially encrypting includes:
the sender data processing system encrypting the message with the second encryption algorithm and then the first encryption algorithm.

15. The sender data processing system of claim 13, wherein the first and second encryption algorithms are a same cryptographic algorithm.

16. The sender data processing system of claim 13, wherein the first and second encryption algorithms are different cryptographic algorithms.

17. The sender data processing system of claim 13, wherein the message comprises a symmetric encryption key.

18. The sender data processing system of claim 13, wherein encrypting the message with the sender private key comprises serially encrypting the message utilizing multiple sender private keys including the sender private key.

19. The sender data processing system of claim 13, wherein encrypting the message with the receiver public key comprises serially encrypting the message utilizing multiple receiver public keys.

20. The sender data processing system of claim 13, wherein encrypting the message comprises serially encrypting the message utilizing multiple private keys including the sender private key and multiple receiver public keys including the receiver public keys.

21. The sender data processing system of claim 13, wherein the communicating includes the sender data processing system refraining from transmitting a separate message digest of the message to the receiver data processing system.

22. A communication system, further comprising:
the sender data processing system of claim 13; and
a receiver data processing system including a network adapter, a processor, and data storage, wherein the receiver data processing system is configured to perform:
serially decrypting the signature-less self-authenticating encrypted message with a first decryption algorithm utilizing a private key of the second key pair and with a second decryption algorithm utilizing a public key of the first key pair, wherein decrypting with the second decryption algorithm verifies the sender data processing system as originating the signature-less self-authenticating encrypted message.

23. The communication system of claim 22, wherein the receiver data processing system refrains from performing a logical comparison operation to verify any digital signature.

24. The communication system of claim 22, wherein the receiver data processing system is configured to perform:
refraining from performing any logical comparison operation to verify the sender processing system as originating the signature-less self-authenticating encrypted message.

25. A program product, comprising:
data storage;
program code stored within the data storage and executable by a processor to cause the processor to perform:
determining a message to be securely transmitted to a receiver data processing system;
generating a signature-less self-authenticating encrypted message by serially encrypting the message with a first encryption algorithm utilizing a private key of a first key pair assigned to the sender data processing system and with a second encryption algorithm utilizing a public key of a second key pair assigned to the receiver data processing system, wherein encrypting with the first encryption algorithm utilizing the private key authenticates the signature-less self-authenticating encrypted message as originating from the sender data processing system; and
communicating the signature-less self-authenticating encrypted message to the receiver data processing system.

26. The program product of claim 25, wherein the serially encrypting includes:
the sender data processing system encrypting the message with the second encryption algorithm and then the first encryption algorithm.

27. The program product of claim 25, wherein the first and second encryption algorithms are a same cryptographic algorithm.

28. The program product of claim 25, wherein the first and second encryption algorithms are different cryptographic algorithms.

29. The program product of claim 25, wherein the message comprises a symmetric encryption key.

30. The program product of claim 25, wherein encrypting the message with the sender private key comprises serially encrypting the message utilizing multiple sender private keys including the sender private key.

31. The program product of claim 25, wherein encrypting the message with the receiver public key comprises serially encrypting the message utilizing multiple receiver public keys.

32. The program product of claim 25, wherein encrypting the message comprises serially encrypting the message utilizing multiple private keys including the sender private key and multiple receiver public keys including the receiver public keys.

33. The program product of claim 25, wherein the communicating includes refraining from transmitting a separate message digest of the message to the receiver data processing system.

34. The program product of claim 25, wherein the program product further causes a processor of the receiver data processing system to perform:
serially decrypting the signature-less self-authenticating encrypted message with a first decryption algorithm utilizing a private key of the second key pair and with a second decryption algorithm utilizing a public key of the first key pair, wherein decrypting with the second decryption algorithm verifies the sender data processing system as originating the signature-less self-authenticating encrypted message.

35. The program product of claim 34, wherein the receiver data processing system refrains from performing a logical comparison operation to verify any digital signature.

36. The program product of claim 34, wherein the receiver data processing system refrains from performing any logical comparison operation to verify the sender processing system as originating the signature-less self-authenticating encrypted message.
